(19) United States
(12) Patent Application Publication
(10) Pub. No.: US 2008/0100160 A1
(43) Pub. Date: May 1, 2008

(54) FAN APPARATUS

(75) Inventors: Naotaka Shibuya, Kyoto (JP); Seung-Sin Yoo, Kyoto (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: NIDEC CORPORATION, Kyoto (JP)

(21) Appl. No.: 11/924,726

(22) Filed: Oct. 26, 2007

(30) Foreign Application Priority Data
Oct. 31, 2006 (JP) 2006-296812

(51) Int. Cl. H02K 7/14; H02K 11/00

(52) U.S. Cl. 310/67 R; 310/71

(57) ABSTRACT

A fan apparatus includes a motor, a circuit board, an impeller having a plurality of rotator blades rotatably driven by the motor, a supporter, an outer frame, and a plurality of stator blades connecting the supporter and the outer frame. An accommodation groove is arranged at least one of the stator blades along the radial direction thereof so as to accommodate therein the conductive wires extending from the circuit board. The conductive wires in the accommodation groove are neatly arranged substantially on top of one another. By virtue of such configuration, the air passage of the fan apparatus will not be interfered by the conductive wires.

### BACKGROUND OF THE INVENTION

1. Field of the Invention

The present invention relates to a fan apparatus.

2. Description of the Related Art

In recent years, as the capacities of an electronic equipment are enhanced, the amount of heat emitted by internal components of the electronic equipment is increased. In order to control the rise in the temperature inside the electronic equipment, a fan apparatus is used.

There are mainly two types of functions for the fan apparatus. They are: (a) to outlet heated air within the electronic component out of a housing accommodating the electronic component, and (b) to provide cool air directly to the heat emitting component within the electronic equipment in order to reduce the temperature of the electronic component. In order to achieve the function (a) above, the fan apparatus is required to have high air flow rate and high static pressure, and to achieve the function (b), efficiency in wind speed distribution is required beside the high air flow rate and high static pressure. Hereinafter, what is meant by the wind speed distribution is a characteristic which defines a distribution of air flow outletted from an air outlet of the fan apparatus. Note that a degree of quietness is also an important element for both functions (a) and (b).

According to the fan apparatus in general, the cool air coming out of the fan apparatus is likely to spread out radially outwardly due to a centrifugal force generated by a rotation of the impeller. However, according to (b) above, it is important that the cool air is not spread out and is directly aimed at the heat emitting object.

In order to minimize the spread of the cool air in the radially outward direction, stator blades are arranged at an end of the fan apparatus the cool air is outletted.

An impeller of the fan apparatus rotates when electric current is supplied from an external power source thereto. Between a motor arranged at a center of the fan apparatus and an outer frame, an air passage is arranged. A conductive wire is arranged crossing the air passage. Therefore, a turbulent flow will be generated by the air flow and the conductive wire, causing a noise level of the fan apparatus to go up.

Therefore, conventionally, as disclosed in Japanese Laid-Open Patent Publication No. 2006-66866 (patent document No. 1), a groove for the conductive wire is arranged at the stator blade and the groove is open toward an outer side of a case.

However, according to patent document 1, since the groove arranged at the stator blade is designed such that a bundle of the conductive wires fits, a thickness of the groove is so great that the air flow of such fan apparatus will be hindered.

In order to overcome such problem, the present invention provides a fan apparatus having a stator blade with a reduced width while allowing the conductive wire to be arranged therein.

### SUMMARY OF THE INVENTION

In order to overcome the problems described above, preferred embodiments of the present invention provide a fan apparatus having an impeller including a plurality of rotor blades, a motor arranged to rotate the impeller in a concentric manner with a predetermined rotary axis, an outer frame arranged to accommodate therein the impeller, a supporter arranged within the outer frame to support the motor, a plurality of stator blades each extending from the supporter in a radial direction, a circuit board arranged to control a rotation of the motor and supported by the supporter, and a plurality of conductive wires each connected to the circuit board. At least three of the stator blades are connected to the supporter and the outer frame. The conductive wires are arranged on top of one another in an axial direction and along one of the stator blades in the radial direction.

Other features, elements, steps, characteristics and advantages of the present invention will become more apparent from the following detailed description of preferred embodiment thereof with reference to the attached drawings.

### BRIEF DESCRIPTION OF THE DRAWING

FIG. 1 is a schematic perspective view of a fan apparatus according to a first preferred embodiment of the present invention.

FIG. 2 is a schematic plan view of the fan apparatus according to the first preferred embodiment of the present invention.

FIG. 3 is a schematic cross sectional view showing a positional relationship between an impeller and a stator blade of the fan apparatus according to the first preferred embodiment of the present invention.

FIG. 4 is a schematic cross sectional view showing a motor attachment portion of the fan apparatus according to the first preferred embodiment of the present invention.

FIG. 5a is a schematic cross sectional view showing a stator blade arranged in the fan apparatus according to the first preferred embodiment of the present invention.

FIG. 5b is a schematic cross sectional view showing a variant of the stator blade arranged in the fan apparatus according to the first preferred embodiment of the present invention.

FIG. 6 is a schematic cross sectional view of another embodiment of a way the conductive wire is arranged.

FIG. 7a is a schematic cross sectional view of a stator blade arranged in a fan apparatus according to a second preferred embodiment of the present invention.

FIG. 7b is a schematic cross sectional view of a variant of the stator blade arranged in the fan apparatus according to the second preferred embodiment of the present invention.

FIG. 8a is a schematic cross sectional view of a stator blade arranged in a fan apparatus according to a third preferred embodiment of the present invention.

FIG. 8b is a schematic cross sectional view of a variant of the stator blade arranged in the fan apparatus according to the third preferred embodiment of the present invention.

FIG. 9 is a schematic perspective view of elements of a fan apparatus according to a fourth preferred embodiment of the present invention.

FIG. 10 is a schematic cross sectional view of what is shown in FIG. 9.

FIG. 11 is a schematic cross sectional view of a stator blade arranged in a fan apparatus according to a fifth embodiment of the present invention.

### DETAILED DESCRIPTION OF PREFERRED EMBODIMENT

Note that in the description of preferred embodiments of the present invention herein, words such as upper, lower, left, right, upward, downward, top and bottom for describing positional relationships between respective member and directions merely indicate positional relationships and directions in the drawings. Such words do not indicate positional relationships and directions of the members mounted in an actual device. Also note that reference numerals, figure numbers and supplementary descriptions are shown below for assisting the reader in finding corresponding components in the description of the preferred embodiments below to facilitate the understanding of the present invention. It is understood that these expressions in no way restrict the scope of the present invention.

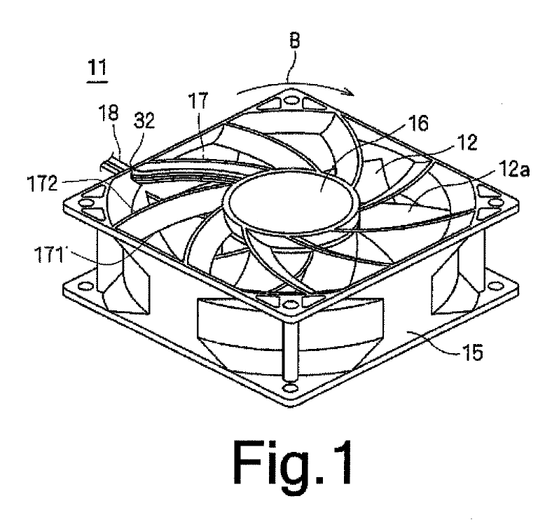

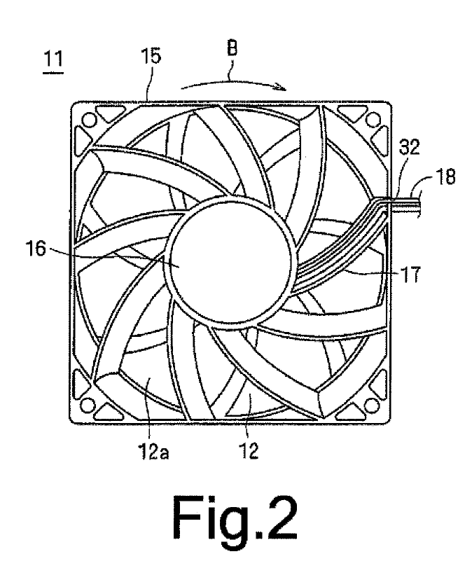

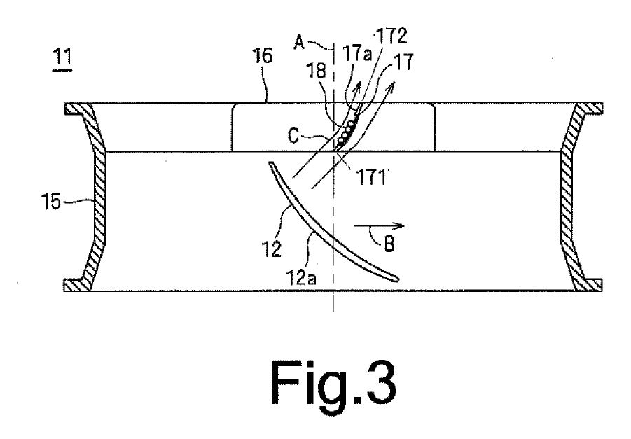

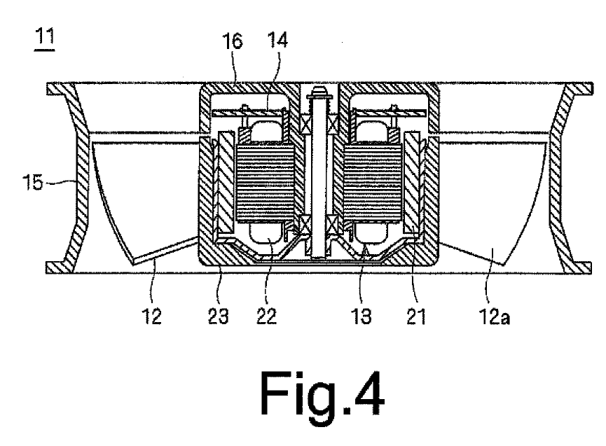

FIG. 1 is a schematic perspective view of a fan apparatus according to a first preferred embodiment of the present invention. FIG. 2 is a schematic plan view of the fan apparatus according to the first preferred embodiment of the present invention. FIG. 3 is a schematic cross sectional view showing a positional relationship between an impeller and a stator blade of the fan apparatus according to the first preferred embodiment of the present invention. FIG. 4 is a schematic cross sectional view showing a motor attachment portion of the fan apparatus according to the first preferred embodiment of the present invention.

A fan apparatus 11, as shown in FIG. 1 and FIG. 4, preferably includes an impeller 12, a motor 13, a circuit board 14, an outer frame 15, a supporter 16, a plurality of stator blades 17, and a plurality of conductive wires 18. The outer frame 15, the supporter 16 and the stator blades 17 are made of a resin material and formed integrally by injection molding.

The impeller 12 which preferably includes a plurality of rotor blades 12a rotates so as to take in air from one side thereof and outlets the air from the other side. The outer frame 15 is arranged such as to surround the impeller 12. The supporter 16 having a substantially discoid shape is arranged inside the outer frame 15 so as to support the motor 13 and the circuit board 14. The stator blades 17 each extend from an outer circumferential portion of the supporter 16 in a radially outward direction of the fan apparatus 11. The supporter 16 is supportedly connected to the outer frame 15 by at least three (according to the present preferred embodiment, each stator blade 17) of the plurality of stator blades 17. Each stator blade 17 preferably includes a first edge portion 171 which is arranged on a side of the rotor blade 12a and a second edge portion 172 arranged on an opposite side of the rotor blade 12a. The stator blade 17 is, as shown in FIG. 1, arranged inclinedly with respect to the rotary axis A such that the first edge portion 171 is arranged following the second edge portion 172 with respect to the rotational direction of the impeller 12 (see FIG. 3). Further, an inwardly curved surface 17a which is a surface of the rotor blade 12a (i.e., surface connecting the first edge portion 171 and the second edge portion 172) facing substantially upward passingly receives the air flow generated by the impeller 12. By virtue of such configuration of the stator blade 17, the air flow generated by the impeller 12 is effectively and accurately directed to a predetermined direction.

Although the stator blades 17 according to the present preferred embodiment of the present invention are arranged below (i.e., an outlet end of the fan apparatus 11) the impeller 12 so as to effectively direct to a predetermined direction the air flow generated by the impeller 12, a variant of the present invention may have the stator blade 17 arranged above (i.e., an inlet end of the fan apparatus 11) the impeller 12. Note that when the stator blade 17 is arranged at the inlet end of the fan apparatus 11, the stator blade 17 will be arranged inclinedly with respect to the rotary axis such that the second edge portion thereof is arranged following the first edge portion with respect to the rotating direction of the impeller.

The motor 13 preferably includes, as shown in FIG. 4, at an inner circumferential surface of the impeller 12 via a rotor holder a rotor magnet 21, and an armature 22 which generates with the rotor magnet 21 a torque. The rotor holder is arranged so as to minimize a leak of magnetic flux to an outside of the impeller 12. Such motor 13 is accommodated in a motor cap portion 23 arranged at a central portion of the impeller 12.

The circuit board 14 preferably includes a control circuit so as to control the rotation of the motor 13. A plurality of conductive wires 18 are connected to the circuit board 14 so as to supply an electric current or the like to the circuit board 14 from an outside power source. The conductive wires 18 are arranged crossing an air passage formed between the outer frame 15 and the supporter 16, and are connected to the outside power source which is arranged outside of the fan apparatus 11. The conductive wires 18 are sometimes used for conducting controlling signal which is for controlling the motor 13.

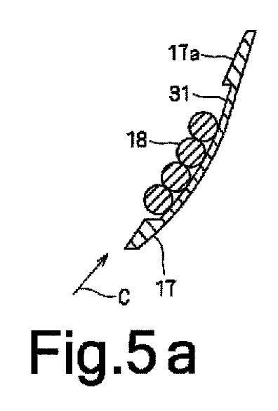

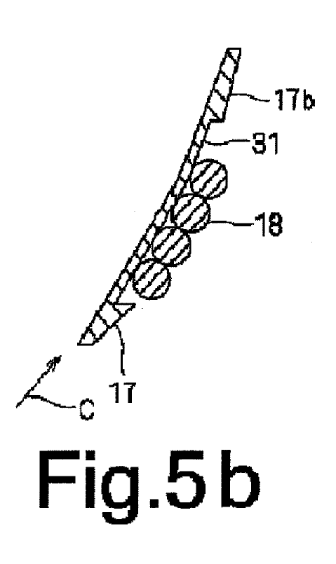

Next, an arrangement concerning the conductive wires 18 according to the present preferred embodiment of the present invention will be described. As shown in FIGS. 1 to 3, and 5a, the plurality of conductive wires 18 are arranged neatly in a row at one of the stator blades 17 in a manner not overlapping one another. Note that an arrow C shown in Figs., for example, FIGS. 3 and 5a, indicates a schematic direction of the air flow generated by the impeller 12.

In particular, according to a configuration shown in FIG. 5a, the stator blade 17 at which the conductive wires 18 will be arranged preferably includes at the inwardly curved surface 17a thereof an accommodation groove 31. As shown in FIG. 5a, the conductive wires 18 are accommodated neatly in the accommodation groove 31 so as to minimize a circumferential thickness of the stator blade 17.

The conductive wires 18 extend from the circuit board 14 accommodated in the supporter 16 to an outside of the fan apparatus 31 via the accommodation groove 31 and a notched portion 32 which is arranged at the outer frame 15.

By virtue of such configuration, the conductive wires 18 will be arranged effectively in one of the stator blades 17 while a circumferential thickness of the stator blade 17 is kept at minimum (i.e., the air passage formed between the outer frame 15 and the supporter 16 will not be reduced substantially). Also, since the conductive wires 18 are accommodated in the stator blade 17, the air flow will not be disturbed (e.g., turbulence), and therefore, the fan apparatus 11 is operable to generate a large air flow and minimize noise generated thereby.

Since the stator blade 17 includes at the inwardly curved surface 17a thereof the accommodation groove 31 which accommodates therein the conductive wires 18, the generation of the air turbulence due to an uneven surface on the stator blade 17 will be minimized.

Also, since the conductive wires 18 are accommodated in the accommodation groove 31, the conductive wires 18 are arranged securely.

Note that although the first preferred embodiment of the present invention assumes that the stator blade 17 includes the accommodation groove 31 at the inwardly curved surface 17a thereof for accommodating therein the conductive wires 18, the stator blade 17 may include the accommodation groove 31 at a surface opposite of the inwardly curved surface 17a (hereinafter, referred to as convex surface 17b) facing substantially downward. Since the airflow passing through the convex surface 17b is substantially gentler than the air flow passing through the inwardly curved surface 17a, an affect the conductive wires 18 have on the air flow is smaller when the conductive wires 18 are arranged at the convex surface 17b.

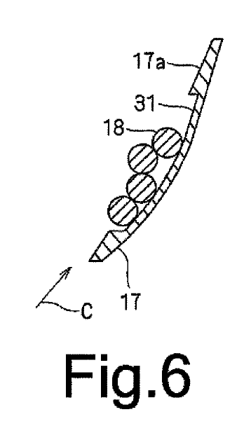

Also, although the first preferred embodiment of the present invention assumes that the plurality of conductive wires 18 are neatly arranged so as not to overlap one another as shown in FIG. 5a, the conductive wires 18 may be arranged as shown in FIG. 6 which shows the conductive wires 18 arranged roughly in a row.

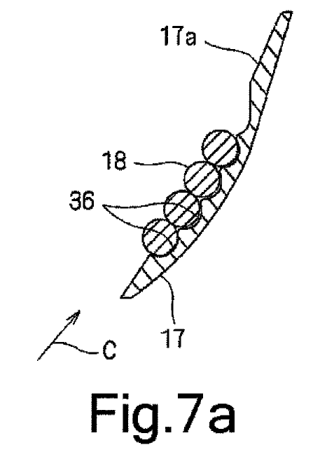

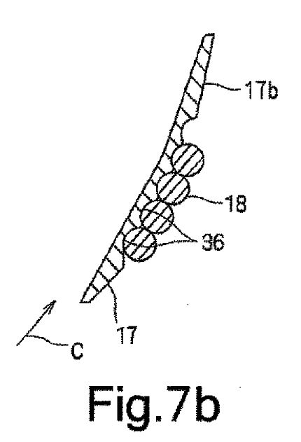

FIG. 7a shows a stator blade arranged in a fan apparatus according to a second preferred embodiment of the present invention. Note that elements similar to those described in the first preferred embodiment of the present invention are denoted by similar reference numerals, and description thereof is omitted.

According to the second preferred embodiment of the present invention, a plurality of accommodation grooves 36 each accommodating therein one of the plurality of conductive wires 18 are arranged at the inwardly curved surface 17a of the stator blade 17. The conductive wires 18 are arranged in a row with respect to one another when they fit in the corresponding accommodation grooves 36.

Also, the accommodation grooves 36 are shaped such as to allow the conductive wires 18 to stably fit therein. Note that since the outer frame 15, supporter 16 and the stator blades 17 are formed integrally as a single component by a mold (e.g., by injection molding using a resin material), the accommodation grooves 36 are shaped such that an upper portion of the mold is removable from a lower portion in the axial direction. Therefore, a shape of the mold may be simplified while no undercutting procedure will be required.

According to the second preferred embodiment of the present invention, the shape of the stator blades 17 will remain substantially as slim as that according to the first preferred embodiment (i.e., the air passage generated between the outer frame 15 and the supporter 16 will not be compromised). Also, since the conductive wires 18 will be accommodated securely and neatly within the stator blade 17, the generation of the air turbulence will be minimized, and therefore, the fan apparatus 11 will achieve a desired flow quantity and a desired noise level.

Note that although the second preferred embodiment of the present invention assumes that the stator blade 17 includes the accommodation groove 31 at the inwardly curved surface 17a thereof for accommodating therein the conductive wires 18, the stator blade 17 may include the accommodation groove 31 at the convex surface 17b. Also, since the air flow passing through the convex surface 17b is substantially gentler than the air flow passing through the inwardly curved surface 17a, the affect the conductive wires 18 have on the air flow is smaller than when the conductive wires 18 are arranged at the convex surface 17b.

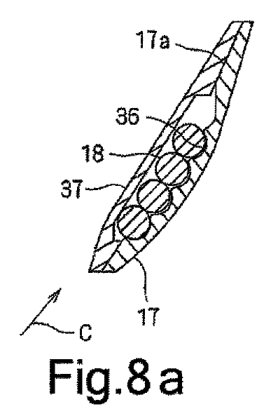

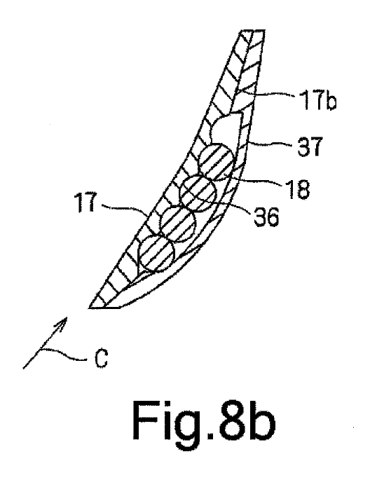

FIG. 8a is a schematic cross sectional view of a stator blade arranged in a fan apparatus according to a third preferred embodiment of the present invention. Note that the fan apparatus according to the third preferred embodiment is substantially identical with the fan apparatus according to the second preferred embodiment except the stator blade 17 at which the conductive wires 18 are accommodated has a cover portion 37, and therefore, elements similar to those described in the second preferred embodiment of the present invention are denoted by similar reference numerals, and description thereof is omitted.

According to the third preferred embodiment of the present invention, as shown in FIG. 8a, the cover portion 37 is arranged covering the conductive wires 18 accommodated in the stator blade 17.

By virtue of such configuration, the shape of the stator blades 17 will remain substantially as slim as that according to the second preferred embodiment (i.e., the air passage generated between the outer frame 15 and the supporter 16 will not be compromised). Also, since the conductive wires 18 will be accommodated securely and neatly within the space generated between the stator blade 17 and the cover portion 37, the generation of the air turbulence will be minimized, and therefore, the fan apparatus 11 will achieve a desired flow quantity and a desired noise level.

Also, since the conductive wires 18 are arranged within the space between the cover portion 37 and the stator blade 17, the conductive wires 18 will be protected from foreign elements (e.g., dust, or the like) which may potentially damage the conductive wires 18.

When the conductive wires 18 are arranged at the convex surface 17b of the stator blade 17, the cover portion 37 will be arranged to cover the convex surface 17b. By virtue of such configuration, the surface of the stator blade 17 at which the conductive wires 18 are arranged will be substantially smooth so as to minimize the generation of air turbulence or the like. Also, the surface of the conductive wires 18 will be protected.

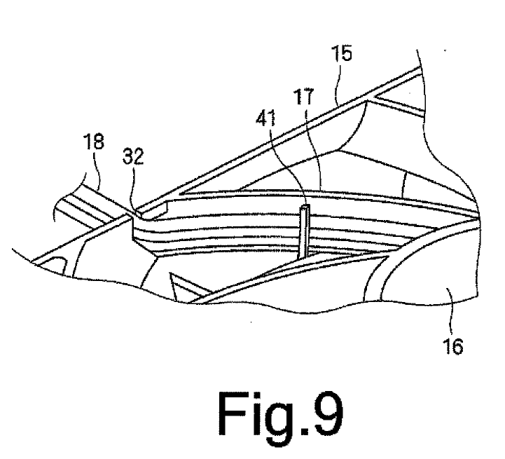

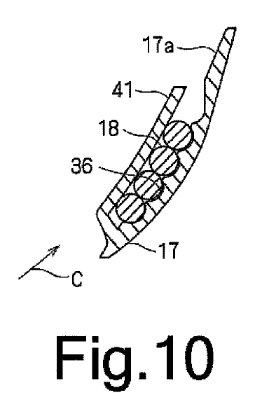

FIG. 9 is a schematic perspective view of a portion of a fan apparatus according to a fourth preferred embodiment of the present invention. FIG. 10 is a cross sectional view of what is shown in FIG. 9. Note that the fan apparatus according to the fourth preferred embodiment is substantially identical with the fan apparatus according to the second preferred embodiment except that the stator blade 17 includes a fixing portion (e.g., a hook 41 in the present embodiment), and therefore, elements similar to those described in the second preferred embodiment of the present invention are denoted by similar reference numerals, and description thereof is omitted.

To be more specific, as shown in FIGS. 9 and 10, the hook 41 is arranged at the stator blade 17 on the inwardly curved surface 17a thereof so as to securely retain the conductive wires 18. The hook 41 is formed integrally with the stator blade 17. Also as shown in FIG. 10, a gap between the hook 41 and the stator blade 17 is equal to or slightly greater than a diameter of the conductive wire 18.

By virtue of such configuration, the fan apparatus according to the fourth preferred embodiment is operable to retain the conductive wires 18 at the accommodation groove 36 arranged at one of the stator blades 17 substantially as effectively as the fan apparatus according to the second preferred embodiment. Also, the hook 41 is operable to minimize a possibility of the conductive wires 18 being removed from the stator blade 17 potentially generating noise when the fan is in operation, or being entangled with the impeller 12.

Note that the fixing portion may be a tape, or the like, instead of the hook 41. Also note that the hook 41 may be arranged at the convex surface 17b of the stator blade 17. When the hook 41 is arranged at the convex surface 17b of the stator blade 17, since the air flow passing through the convex surface 17b is substantially gentler than the air flow passing through the inwardly curved surface 17a, the affect the conductive wires 18 have on the air flow is smaller.

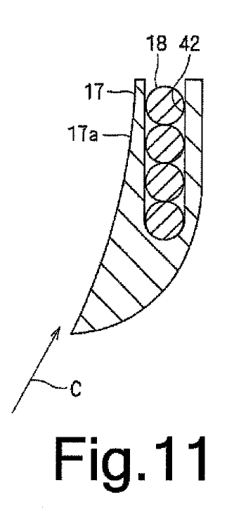

FIG. 11 is a schematic cross sectional view of a stator blade arranged at a fan apparatus according to a fifth preferred embodiment of the present invention. Note that the fan apparatus according to the first preferred embodiment is substantially identical with the fan apparatus according to the fifth preferred embodiment except that a configuration of the stator blade 17 at which the conductive wires 18 are arranged, and therefore, elements similar to those described in the fifth preferred embodiment of the present invention are denoted by similar reference numerals, and description thereof is omitted.

As shown in FIG. 11, according to the present preferred embodiment, the stator blade 17 at which the conductive wires 18 are arranged preferably includes an accommodation groove 42 having an opening facing toward the outlet end of the fan apparatus. The conductive wire 18 extending from the supporter 16 to the outer frame 15 will be arranged in a non-overlapping manner in the accommodation groove 42.

By virtue of such configuration in which the plurality of conductive wires 18 are arranged effectively in one of the stator blade 17 while the circumferential thickness of the stator blade 17 is kept at minimum (i.e., the air passage formed between the outer frame 15 and the supporter 16 will not be reduced substantially). Also, since the conductive wires 18 are accommodated in the stator blade 17, the air flow will not be disturbed (e.g., turbulence), ad therefore, the fan apparatus 11 is operable to generate a large air flow and minimize noise generated thereby.

Also, by virtue of such configuration, the fan apparatus according to the present preferred embodiment is operable to retain the conductive wires 18 at the accommodation groove 42 arranged at one of the stator blades 17 substantially as effective as the fan apparatus according to the fourth embodiment. Also, since the opening of the accommodation groove 42 will not interfere with the air flow generated by the impeller 12 when the fan is in operation.

What is claimed is:

1. A fan apparatus comprising:
an impeller including a plurality of rotor blades;
a motor arranged to rotate the impeller in a concentric manner with a predetermined rotary axis;
an outer frame arranged to accommodate therein the impeller;
a supporter arranged within the outer frame to support the motor;
a plurality of stator blades each extending from the supporter in a radial direction;
a circuit board arranged to control a rotation of the motor and supported by the supporter; and
a plurality of conductive wires each connected to the circuit board, wherein
at least three of the stator blades are connected to the supporter and the outer frame, and
the conductive wires are arranged on top of one another in an axial direction and along one of the stator blades in the radial direction.

2. The fan apparatus according to claim 1, wherein the one of the stator blade includes an accommodation groove accommodating therein the conductive wires.

3. The fan apparatus according to claim 2, wherein the stator blade includes a plurality of accommodation grooves each fittingly accommodating one of the plurality of conductive wires.

4. The fan apparatus according to claim 1, wherein a portion of the stator blade at which the conductive wires are arranged is covered by a cover portion.

5. The fan apparatus according to claim 1, wherein at least a portion of the conductive wires are stabilized at a fixing portion.

6. The fan apparatus according to claim 1, wherein the conductive wires are arranged at an inlet side or at an outlet side in an axial direction of the stator blade.

7. The fan apparatus according to claim 2, wherein the accommodation grooves are open toward an outlet side in an axial direction while the conductive wires are arranged therein.
